(19) United States
(12) Patent Application Publication
(10) Pub. No.: US 2024/0029596 A1
(43) Pub. Date: Jan. 25, 2024

(54) ELECTRONIC SHELF LABEL AND CONTROLLING METHOD THEREFOR

(71) Applicant: RAINUS CO., LTD., Seongnam-si, Gyeonggi-do (KR)

(72) Inventors: Jong Woo SUNG, Seongnam-si, Gyeonggi-do (KR); Hyun-Hak KIM, Seongnam-si, Gyeonggi-do (KR)

(21) Appl. No.: 17/908,385

(22) PCT Filed: Sep. 25, 2020
(86) PCT No.: PCT/KR2020/013049

§ 371 Date: Aug. 31, 2022

(30) Foreign Application Priority Data
Jul. 3, 2020 (KR) 10-2020-0082113

(51) Int. Cl. G09F 13/22; G09F 7/00

(52) U.S. Cl. CPC G09F 13/22; G09F 7/00; G09F 2007/005; G09F 2007/1873

(57) ABSTRACT

According to an embodiment of the present disclosure, an electronic shelf label includes a display configured to display information to a user using one or more virtual cells, a sensing module configured to obtain external environment information, and a controller configured to control information displayed on one or more virtual cells based on the external environment information obtained by the sensing module. The electronic shelf label according to the present disclosure is used to adjust the information displayed on the one or more virtual cells based on the external environment information obtained by the sensing module, thereby displaying various pieces of information to the user.

### TECHNICAL FIELD

The present disclosure relates to an electronic shelf label and a controlling method thereof, and more particularly, to an electronic shelf label that may display various pieces of information based on external environment information obtained by a sensing module and a controlling method thereof.

### BACKGROUND ART

A large number of products on sale are displayed on a display stand in stores such as large marts. A label of recording product information such as product name, product price, and product shelf-life is attached to the display stand, and customers may identify the product information by checking the label.

The displayed products are sold within a short time period in stores where products are quickly distributed, so the product information displayed on the label may be frequently changed. Therefore, an electronic shelf label (ESL) is widely used in stores to easily change the product information displayed on the label and to repeatedly use.

The ESL receives and displays various pieces of product information including price information. The ESL is a substitute for other paper labels and may display product information.

FIG. 1 shows a conventional ESL used to display product information on product displayed on a display stand of a store.

Referring to FIG. 1, it may be seen that a plurality of ESLs 10 are used to display product information on a plurality of products displayed on the display stand. In order to display the product information on the ESL 10 as described above, a store manager may place the ESL 10 according to the position of the product displayed on the display stand and map the individual ESL 10 to the displayed product using a terminal device 20 such as a PDA. Specifically, a process of storing mapping information in a management server 30 by reading the unique number of the ESL 10 and an identification code of the product to be mapped by the terminal device 20 using means such as a barcode or NFC is performed. Subsequently, the ESL 10 receives the information on the mapped product from the management server 30 and displays the product information.

The electronic shelf label 10 as described above only receives the mapped product information from the terminal device 20 from the management server 30 and displays the mapped product information, but does not perform other functions. Therefore, there is a need for development of an electronic shelf label capable of performing various functions.

### DISCLOSURE

### Technical Problem

The present disclosure provides an electronic shelf label that may control displayed information based on external environment information and a controlling method thereof.

The present disclosure further provides an electronic shelf label that may transmit an abnormality notification based on the external environment information and a controlling method thereof.

The objects of the present disclosure are not limited to the above-mentioned objects, and other objects and advantages of the present disclosure that are not mentioned may be understood by the following description, and will be more clearly understood by embodiments of the present disclosure. In addition, it will be easily understood that the objects and advantages of the present disclosure may be realized by features described in claims and a combination thereof.

### Technical Solution

According to an embodiment of the present disclosure, an electronic shelf label includes a display configured to display information to a user using one or more virtual cells; a sensing module configured to obtain external environment information; and a controller configured to control information displayed on the one or more virtual cells based on the external environment information obtained by the sensing module.

In addition, according to an embodiment of the present disclosure, the sensing module of the electronic shelf label includes one or more cameras configured to obtain an image as the external environment information and the controller is configured to adjust the information displayed on the one or more virtual cells based on user information included in the image obtained by the one or more cameras.

In addition, according to an embodiment of the present disclosure, the controller of the electronic shelf label is configured to: transmit the image obtained by the one or more cameras to a management server and receive information to be displayed on the one or more virtual cells from the management server.

In addition, according to an embodiment of the present disclosure, the sensing module of the electronic shelf label includes one or more temperature sensors configured to obtain a temperature as the external environment information and the controller is configured to control the temperature obtained by the one or more temperature sensors to be displayed on the one or more virtual cells.

In addition, according to an embodiment of the present disclosure, the controller of the electronic shelf label is configured to: based on the temperature obtained by the one or more temperature sensors being not within a preset reference temperature range, transmit an abnormality notification to a management server.

In addition, according to an embodiment of the present disclosure, the sensing module of the electronic shelf label includes one or more humidity sensors configured to obtain humidity as the external environment information and the controller is configured to control the humidity obtained by the one or more humidity sensors to be displayed on the one or more virtual cells.

In addition, according to an embodiment of the present disclosure, the controller of the electronic shelf label is configured to: based on the humidity obtained by the one or more humidity sensors being not within a preset reference humidity range, transmit an abnormality notification to a management server.

In addition, according to an embodiment of the present disclosure, the sensing module of the electronic shelf label includes one or more illuminance sensors configured to obtain illuminance as the external environment information and the controller is configured to adjust brightness of the display based on the illuminance obtained by the one or more illuminance sensors.

In addition, according to an embodiment of the present disclosure, the sensing module of the electronic shelf label includes one or more microphones configured to obtain a voice as the external environment information and the controller is configured to adjust the information displayed by the display based on the voice obtained by the one or more microphones.

In addition, according to an embodiment of the present disclosure, the sensing module of the electronic shelf label includes one or more dust detection sensors configured to obtain concentration of dust in the air as the external environment information and the controller is configured to control the dust concentration obtained by the one or more dust detection sensors to be displayed on the one or more virtual cells.

In addition, according to an embodiment of the present disclosure, the electronic shelf label further includes a speaker configured to output a voice comprising the information displayed on the one or more virtual cells.

In addition, according to an embodiment of the present disclosure, the controller is configured to control: based on the display of the electronic shelf label receiving an input of selecting any one of the one or more virtual cells from the user, only information displayed on a virtual cell selected by the user using the external environment information obtained by the sensing module.

In addition, according to an embodiment of the present disclosure, a method for controlling an electronic shelf label includes: displaying information to a user using one or more virtual cells of a display; obtaining external environment information by a sensing module; adjusting, by a controller, the information displayed on the one or more virtual cells based on the external environment information obtained by the sensing module; and outputting, by the controller and on the display, the information displayed on the one or more virtual cells adjusted based on the external environment information.

In addition, according to an embodiment of the present disclosure, for the method, obtaining the external environment information includes obtaining an image as the external environment information by one or more cameras of the sensing module, adjusting the information displayed on the one or more virtual cells includes: adjusting, by the controller, the information displayed on the one or more virtual cells based on user information included in the image obtained by the one or more cameras and adjusting the information displayed on the one or more virtual cells further includes: transmitting, by the controller, the image obtained by the one or more cameras to a management server after obtaining the image as the external environment information by the one or more cameras; and receiving, by the controller, information to be displayed on the one or more virtual cells from the management server.

In addition, according to an embodiment of the present disclosure, for the method, obtaining the external environment information includes obtaining a temperature as the external environment information by one or more temperature sensors of the sensing module, adjusting the information displayed on the one or more virtual cells includes: controlling, by the controller, the temperature obtained by the one or more temperature sensors to be displayed on the one or more virtual cells, and adjusting the information displayed on the one or more virtual cells further includes transmitting, by the controller, an abnormality notification to a management server based on the temperature obtained by the one or more temperature sensors being not within a preset reference temperature range.

In addition, according to an embodiment of the present disclosure, for the method, obtaining the external environment information includes obtaining humidity as the external environment information by one or more humidity sensors of the sensing module, adjusting the information displayed on the one or more virtual cells includes controlling, by the controller, the humidity obtained by the one or more humidity sensors to be displayed on the one or more virtual cells, and adjusting the information displayed on the one or more virtual cells further includes transmitting, by the controller, an abnormality notification to a management server based on the humidity obtained by the one or more humidity sensors being not within a preset reference humidity range.

In addition, according to an embodiment of the present disclosure, for the method, obtaining the external environment information includes obtaining illuminance as the external environment information by one or more illuminance sensors of the sensing module and obtaining the external environment information further includes adjusting, by the controller, brightness of the display based on the illuminance obtained by the one or more illuminance sensors.

In addition, according to an embodiment of the present disclosure, for the method, obtaining the external environment information includes obtaining a voice as the external environment information by one or more microphones of the sensing module and adjusting the information displayed on the one or more virtual cells includes adjusting, by the controller, the information displayed by the display based on the voice obtained by the one or more cameras.

In addition, according to an embodiment of the present disclosure, for the method, obtaining the external environment information includes obtaining a concentration of dust in the air as the external environment information by one or more dust detection sensors of the sensing module and adjusting the information displayed on the one or more virtual cells includes controlling, by the controller, the dust concentration obtained by the one or more dust detection sensors to be displayed on the one or more virtual cells.

In addition, according to an embodiment of the present disclosure, for the method, adjusting the information displayed on the one or more virtual cells includes: adjusting, by the controller, only information displayed on the virtual cell selected by the user using the external environment information obtained by the sensing module based on the display receiving an input of selecting any one of the one or more virtual cells from the user.

### Advantageous Effects

According to the present disclosure, an electronic shelf label and a controlling method thereof are used to adjust information displayed on one or more virtual cells based on external environment information obtained by a sensing module, thereby displaying various pieces of information to a user.

In addition, according to the present disclosure, the electronic shelf label and the controlling method thereof are used to transmit an abnormality notification based on the external environment information, thereby distributing products in a more suitable environment.

In addition to the above-described effects, further effects of the present disclosure are described together with explanations of specific matters to implement the present disclosure.

### DESCRIPTION OF DRAWINGS

FIG. 1 shows a conventional electronic shelf label used to display product information of a product displayed on a display stand of a store.

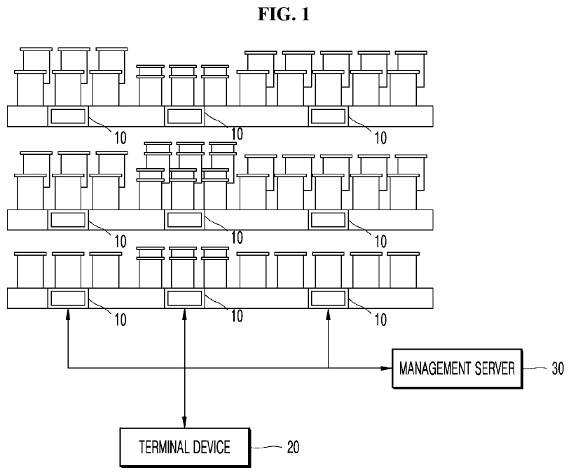

FIG. 2 is a block diagram of an electronic shelf label according to an embodiment of the present disclosure.

FIG. 3 is a block diagram of a sensing module of an electronic shelf label according to an embodiment of the present disclosure.

FIG. 4 shows an embodiment in which a controller of an electronic shelf label according to an embodiment of the present disclosure controls to display external environment information obtained by a sensing module on one or more virtual cells.

FIG. 5 shows an embodiment in which a controller of an electronic shelf label according to an embodiment of the present disclosure adjusts information displayed on one or more virtual cells based on user information included in an image obtained by one or more cameras.

FIG. 6 shows an embodiment in which a controller of an electronic shelf label according to an embodiment of the present disclosure adjusts information displayed on one or more virtual cells based on voice obtained by one or more microphones.

FIG. 7 is a flowchart of a method for controlling an electronic shelf label according to an embodiment of the present disclosure.

### BEST MODE

The above-mentioned objects, features, and advantages of the present disclosure are described in detail with reference to accompanying drawings. Therefore, the skilled person in the art to which the present disclosure pertains may easily embody the technical idea of the present disclosure. In the description of the present disclosure, a detailed description of a well-known technology relating to the present disclosure may be omitted if it unnecessarily obscures the gist of the present disclosure. Hereinafter, preferred embodiments of the present disclosure are described in detail with reference to the accompanying drawings. In the drawings, same reference numerals are used to refer to same or similar components.

Terms such as first, second, and the like may be used herein to describe various elements of the present disclosure. These elements are not limited by these terms. These terms are intended to distinguish one element from another element. A first element may be a second element unless otherwise stated.

Further, the terms “connected,” “coupled,” or the like are used such that, where a first component is connected or coupled to a second component, the first component may be directly connected or able to be connected to the second component, or one or more additional components may be disposed between the first and second components, or the first and second components may be connected or coupled through one or more additional components.

Singular expressions used in the present disclosure include plural expressions unless the context clearly displays otherwise. In the present disclosure, terms such as “including” or “comprising” should not be construed as necessarily including all of the various components, or various steps described in the present disclosure, and terms such as “including” or “comprising” should be construed as not including some elements or some steps or further including additional elements or steps.

Unless otherwise stated, each component may be singular or plural throughout the disclosure.

Hereinafter, an electronic shelf label according to some embodiments of the present disclosure and a controlling method thereof are described.

Hereinafter, a user refers to any person using the electronic shelf label. In addition, a manager refers to a person using the electronic shelf label to manage products sold in the store among users and a consumer refers to a person using the electronic shelf label to obtain product information or purchase products in a store among users.

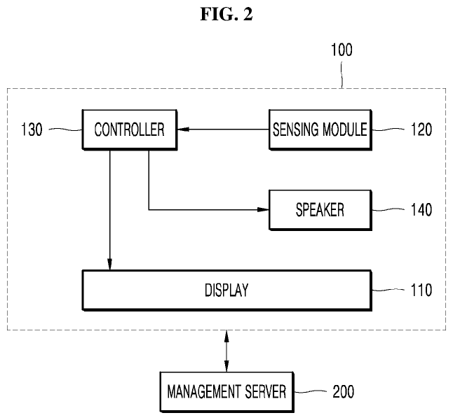

FIG. 2 is a block diagram of an electronic shelf label according to an embodiment of the present disclosure.

Referring to FIG. 2, an electronic shelf label 100 according to an embodiment of the present disclosure includes a display 110, a sensing module 120, and a controller 130. In addition, the electronic shelf label 100 according to an embodiment of the present disclosure may further include a speaker 140.

According to an embodiment of the present disclosure, the electronic shelf label 100 may have a bar shape and a horizontal length thereof is longer than a vertical length thereof when the electronic shelf label 100 is coupled to a display stand. With the bar shape of the electronic shelf label 100, an electronic shelf label 100 may display product information on a plurality of products.

The display 110 displays information to the user using one or more virtual cells. The display 110 may be a touch screen capable of displaying information to the user on the screen while receiving the touch input from the user. In this case, the display 110 may receive a touch input from a user, transmit the touch input to the controller 130, and display the information to the user according to a command received from the controller 130.

The sensing module 120 obtains external environment information. The external environment information is information informing of a situation of a place where the electronic shelf label 100 is disposed, may include a temperature, humidity, and illuminance of the place where the electronic shelf label 100 is disposed, and may include information such as voices and facial expressions of users moving around the place where the electronic shelf label 100 is disposed.

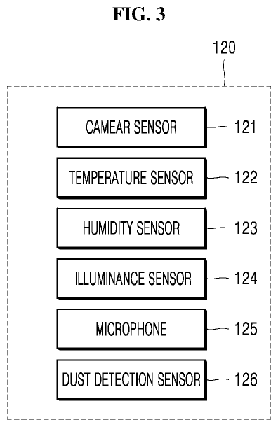

The sensing module 120 may obtain the external environment information using a camera, a temperature sensor, a humidity sensor, an illuminance sensor, a microphone, and the like. A more detailed operation of the sensing module 120 and processing of the external environment information are described below with reference to FIG. 3.

The controller 130 controls information displayed on one or more virtual cells based on the external environment information obtained by the sensing module 120. The controller 130 may include a memory to store instructions for controlling information displayed on one or more virtual cells based on external environment information obtained by the sensing module 120, a processor to process instructions stored in the memory, and a communication module to communicate with a management server 200 described below.

The controller 130 may control the display 110 to be basically operated in a consumer mode or a manager mode.

The consumer mode is a mode in which product information is displayed to the consumer. When the electronic shelf label 100 is operated in the consumer mode, the controller 130 may control the display 110 to display a different screen according to the input received through the display 110. In addition, when the electronic shelf label 100 is operated in the consumer mode, the controller 130 may transmit data to the management server 200 described below based on the input received through the display 110.

The manager mode is a mode in which the user may set the screen displayed in the consumer mode. When the electronic shelf label is operated in the manager mode, the user applies the input to the display 110 to divide the screen displayed on the display 110 into virtual cells and match the divided virtual cell to the product.

When the electronic shelf label 100 according to an embodiment of the present disclosure described below is operated in the consumer mode, the electronic shelf label 100 according to an embodiment of the present disclosure is an electronic shelf label 100 capable of displaying various pieces of information based on the external environment information obtained by the sensing module 120.

The speaker 140 outputs a voice including information displayed on one or more virtual cells. Such a speaker 140 allows the user in the store to identify the product information displayed on the electronic shelf label 100 without looking at the product information. The speaker 140 may be a directional speaker to output voice only in a specific direction in order for the voice output by the electronic shelf label 100 from the speaker 140 to not be the same as the voice output from other electronic shelf labels 100.

The management server 200 stores product information on a product displayed on a display stand of a store. That is, the management server 200 stores a product identification code of each of all products displayed in the store and product information corresponding thereto. In addition, the management server 200 may store various pieces of information necessary for the operation of the electronic shelf label 100.

The management server 200 communicates with the controller 130 of the electronic shelf label 100. The management server 200 may transmit product information to be displayed on the screen of the display 110 of the electronic shelf label 100 and receive product information currently displayed on the electronic shelf label 100.

In addition, the management server 200 may process various calculations based on data received from the electronic shelf label 100.

FIG. 3 is a block diagram of a sensing module of an electronic shelf label according to an embodiment of the present disclosure.

Referring to FIG. 3, a sensing module 120 of an electronic shelf label 100 according to an embodiment of the present disclosure may include at least one of one or more cameras 121, one or more temperature sensors 122, one or more humidity sensors 123, one or more illuminance sensors 124, one or more microphones 125, or one or more dust detection sensors 126.

The one or more cameras 121 may obtain an image as external environment information. In more detail, the one or more cameras 121 may capture a space where the electronic shelf label 100 is disposed and obtain the captured image as external environment information. In an embodiment of the present disclosure, the one or more cameras 121 may capture the face of a user looking at the display 110.

In addition, the one or more cameras 121 may transmit the captured image to the controller 130.

The controller 130 may adjust information displayed on a virtual cell based on user information included in the image obtained by the one or more cameras 121.

In an embodiment of the present disclosure, the controller 130 may recognize the face of a person of an image captured by the one or more cameras 121 and obtain user information of the person of the image captured by the one or more cameras 121 based on the recognition result thereof. In addition, the controller 130 may control information displayed on one or more virtual cells of the display 110 based on the obtained user information. For example, the controller 130 may display price information on price to which a different discount rate is applied based on user information on the one or more virtual cells.

In this case, the controller 130 may directly recognize the face of the person of the image, obtain user information based on the recognition result thereof, transmit the image captured by the one or more cameras 121 to a management server 200, and receive information to be displayed on the one or more virtual cells from the management server 200. As described above, the controller 130 does not directly perform facial recognition. In this case, calculation burden of the controller 130 of the electronic shelf label 100 is reduced. Therefore, the price of the electronic shelf label 100 may be reduced and the size of the electronic shelf label 100 may also be reduced.

In another embodiment of the present disclosure, the controller 130 may analyze the facial expression of the person of the image captured by the one or more cameras 121. In this case, the controller 130 may transmit the image captured by the one or more cameras 121 to the management server 200, and the management server 200 may analyze the facial expression of the person of the captured image. As described above, the controller 130 may analyze the facial expression of the person of the image obtained as external environment information and may indirectly obtain an opinion of a customer on the product based on the analyzing result thereof.

In yet another embodiment of the present disclosure, the controller 130 may recognize barcode information, a user ID, and the like of the image captured by the one or more cameras 121 and obtain barcode information of the image captured by the one or more cameras 121 and user information corresponding to user ID based on the recognition result thereof. In addition, the controller 130 may control information displayed on one or more virtual cells of the display 110 based on the obtained user information. For example, the controller 130 may display price information on price to which a different discount rate is applied on one or more virtual cells based on user information.

The one or more temperature sensors 122 may obtain the temperature as external environment information. In more detail, the one or more temperature sensors 122 may detect a temperature of a space where the electronic shelf label 100 is disposed or a space where the product displayed by the electronic shelf label 100 is disposed, and obtain the detected temperature as external environment information.

The one or more temperature sensors 122 may transmit the sensed temperature information to the controller 130. In addition, the controller 130 may control the temperature obtained by the one or more temperature sensors 122 to be displayed on one or more virtual cells.

In addition, based on the temperature obtained by the one or more temperature sensors 122 being not within a preset reference temperature range, the controller 130 may transmit an abnormality notification to the management server 200. In this case, the reference temperature range may be preset by the user and may be set differently depending on the type of product displayed by the electronic shelf label 100 including the one or more temperature sensors 122.

In more detail, if a space where the temperature sensor 122 detects a temperature is a space where a product requiring storage at a specific temperature is disposed, when the temperature detected by the temperature sensor 122 is not within the reference temperature range, there is a fear of product deterioration. In this case, the controller 130 may transmit the abnormality notification to the management server 200.

As described above, the controller 130 transmits the abnormality notification to the management server 200. Therefore, the user may more conveniently manage the temperature of the display stand where the product is located.

The one or more humidity sensors 123 may obtain humidity as external environment information. In more detail, the one or more humidity sensors 123 may detect the humidity of a space where the electronic shelf label 100 is disposed or a space where the product displayed by the electronic shelf label 100 is disposed, and obtain the detected humidity as external environment information.

The one or more humidity sensors 123 may transmit the sensed humidity information to the controller 130. In addition, the controller 130 may control the humidity obtained by the one or more humidity sensors 123 to be displayed on one or more virtual cells.

In addition, based on the humidity obtained by the one or more humidity sensors 123 being not within a preset reference humidity range, the controller 130 may transmit an abnormality notification to the management server 200. In this case, the reference humidity range may be preset by the user and may be set differently depending on the type of product displayed by the electronic shelf label 100 including the one or more humidity sensors 123.

In more detail, if a space where the humidity sensor 123 detects humidity is a space where a product that requires storage at a specific humidity is located, when the humidity detected by the humidity sensor 123 is not within the reference humidity range, there is a fear of product deterioration. Therefore, the controller 130 may transmit an abnormality notification to the management server 200.

The controller 130 transmits the abnormality notification to the management server 200 as described above. Therefore, the user may more conveniently manage the humidity of the display stand where the product is disposed.

The one or more illuminance sensors 124 may obtain illuminance as external environment information. In more detail, the one or more illuminance sensors 124 may detect illuminance of the space where the electronic shelf label 100 is disposed, and obtain the sensed illuminance as external environment information.

The one or more illuminance sensors 124 may transmit the sensed illuminance information to the controller 130.

The controller 130 may adjust brightness of the display 110 based on the illuminance obtained by the one or more illuminance sensors 124.

In an embodiment of the present disclosure, the controller 130 may adjust the brightness of the display 110 using an illuminance table. The illuminance table includes the brightness of the display 110 to be set based on the illuminance obtained by the illuminance sensor 124, and the controller 130 may control the brightness of the display 110 to a brightness corresponding to the illuminance obtained by the one or more illuminance sensors 124.

As described above, the controller 130 adjusts the brightness of the display 110 in order for the user to easily identify information displayed on the display 110.

The one or more microphones 125 may obtain voice as external environment information. In more detail, the one or more microphones 125 may obtain all voice generated in the space where the electronic shelf label 100 is disposed as external environment information. In this case, the microphone 125 may be a directional microphone in order for the electronic shelf label 100 to detect only voice generated in the special area.

In addition, the one or more microphones 125 may transmit the detected voice to the controller 130.

The controller 130 may adjust information displayed by the display 110 based on the voice obtained by the one or more microphones 125.

In an embodiment of the present disclosure, when the controller 130 detects that the voice obtained by the one or more microphones 125 includes information indicating that the user wants to obtain additional product information, the controller 130 may display other piece of information, which is not currently displayed, on the one or more virtual cells.

The one or more dust detection sensors 126 may obtain a concentration of dust in the air as external environment information. In more detail, the one or more dust detection sensors 122 may detect the concentration of the dust in the air in the space where the electronic shelf label 100 is disposed, and obtain the detected concentration of the dust as external environmental information.

The one or more dust detection sensors 122 may send the detected dust concentration information to the controller 130. In addition, the controller 130 may control the concentration of dust obtained by the one or more dust detection sensors 122 to be displayed on the one or more virtual cells.

In this case, the one or more dust detection sensors 122 may obtain the concentration of fine dust as external environment information, irrespective of the concentration of general dust in the air. In addition, the controller 130 may control the concentration of the fine dust obtained by the one or more dust detection sensors 122 to be displayed on the one or more virtual cells.

In addition, the controller 130 may transmit, to the management server 200, the concentration information of dust or the concentration information of fine dust obtained as the external environment information.

The controller 130 transmits the concentration information of the dust or the concentration information of the fine dust to the management server 200 as described above. Therefore, the air in the store may be comfortably managed by an apparatus such as an air conditioner.

As described above, the controller 130 may control the display 110 based on the external environment information obtained by the sensing module 120.

In this case, when the controller 130 receives an input of selecting any one of the one or more virtual cells from the display 110, the controller 130 may control only information displayed on a virtual cell selected by the user based on the external environment information obtained by the sensing module 120.

For example, based on the reception of the input selecting one of the one or more virtual cells from the display, which was received from the user, and the detection that the voice obtained by the one or more microphones 125 includes the information indicating that the user wants to obtain the additional product information, the controller 130 may control other pieces of information, which is not currently displayed, on the virtual cell selected by the user.

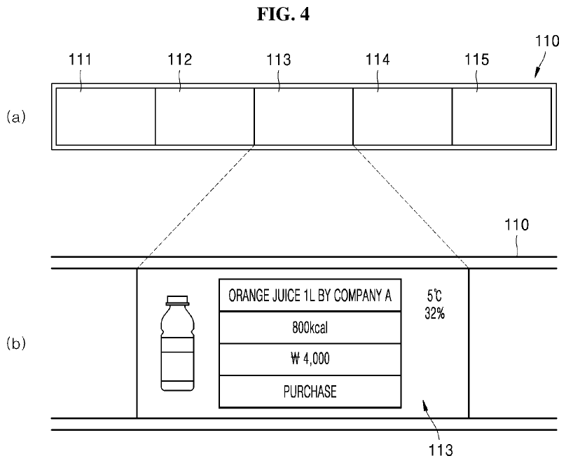

An embodiment in which the controller 130 controls the display 110 based on the external environment information obtained by the sensing module 120 as described above may be confirmed with reference to FIGS. 4 to 6.

FIG. 4 shows an embodiment in which a controller of an electronic shelf label according to an embodiment of the present disclosure controls to display external environment information obtained by a sensing module on one or more virtual cells.

Referring to (a) of FIG. 4, it may be seen that a display 110 displays information by dividing a screen into one or more virtual cells 111, 112, 113, 114, and 115. (a) of FIG. 4 shows an embodiment in which the display 110 is divided into five virtual cells having the same size, but the present disclosure is not limited thereto, and the display 110 may be divided into one or more virtual cells having different sizes.

Referring to (b) of FIG. 4, it may be seen that information displayed on a third virtual cell 113 of (a) of FIG. 4 is enlarged. The display 110 displays a product picture, the product name, product calorie, product price, and the like as product information on the third virtual cell 113. In addition, the display 110 displays a temperature and humidity, which are external environment information detected by the sensing module 120, on an upper right side of the virtual cell.

As described above, the electronic shelf label 100 according to the present disclosure adjusts the information displayed on one or more virtual cells based on the external environment information obtained by the sensing module 120 to display various pieces of information to the user.

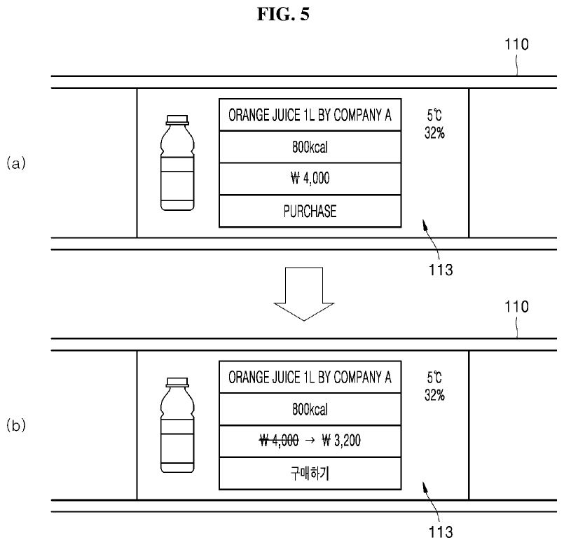

FIG. 5 shows an embodiment in which a controller of an electronic shelf label according to an embodiment of the present disclosure adjusts information displayed on one or more virtual cells based on user information included in an image obtained by one or more cameras.

Referring to (a) of FIG. 5, it may be seen that an electronic shelf label 100 displays product information, a temperature and humidity, which are external environment information, on a display 110. The controller 130 may obtain user information based on an image obtained by one or more cameras 121. Then, the controller 130 may adjust the information displayed on the display 110 as shown in (b) of FIG. 5.

Referring to (b) of FIG. 5, it may be seen that an electronic shelf label 100 displays price information on the display thereof by applying a discount rate based on user information and adjusting the price.

As described above, the electronic shelf label 100 according to the present disclosure adjusts the information displayed on the one or more virtual cells based on the external environment information obtained by the sensing module 120 to display different piece of information depending on the user located nearby.

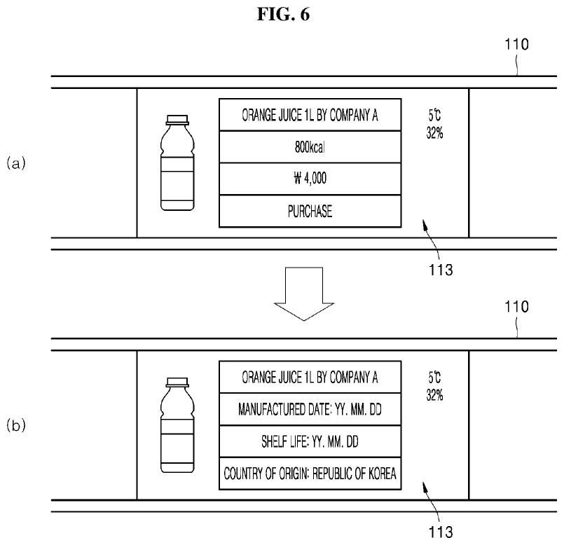

FIG. 6 shows an embodiment in which a controller of an electronic shelf label according to an embodiment of the present disclosure adjusts information displayed on one or more virtual cells based on a voice obtained by one or more microphones.

Referring to (a) of FIG. 6, it may be seen that an electronic shelf label 100 displays product information, a temperature, and humidity, which are external environment information, on a display 110. In this case, the controller 130 may adjust the information displayed by the display 110 based on voice obtained by one or more microphones 125. For example, if the voice obtained by the one or more microphones 125 includes information indicating that the user wants to display additional product information, the controller 130 may adjust the screen displayed by the display 110 as shown in (b) of FIG. 6.

Referring to (b) of FIG. 6, it may be seen that the product information displayed by the electronic shelf label 100 is changed to the manufactured date, shelf-life, and the country of origin.

As described above, the electronic shelf label 100 according to the present disclosure adjusts the information displayed on one or more virtual cells based on the external environment information obtained by the sensing module 120 to display information desired by the user.

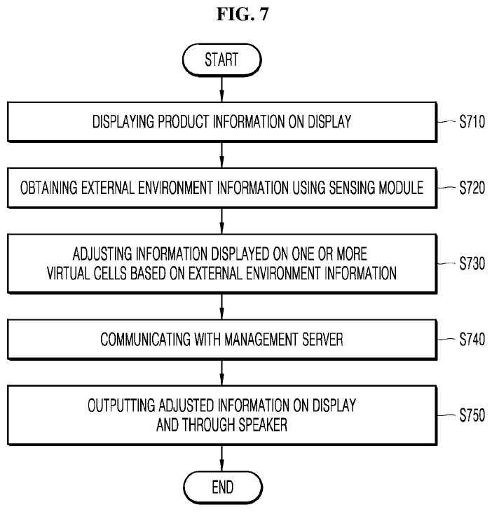

FIG. 7 is a flowchart of a method for controlling an electronic shelf label according to an embodiment of the present disclosure.

Referring to FIG. 7, an electronic shelf label 100 may display product information on a display 110 (S710). The electronic shelf label 100 may display product information as shown in FIGS. 4 to 6.

The electronic shelf label 100 may obtain external environment information using a sensing module 120 (S720). That is, the electronic shelf label 100 may obtain external environment information using at least one of one or more cameras 121, one or more temperature sensors 122, one or more humidity sensors 123, one or more illuminance sensors 124, one or more microphones 125, or one or more dust detection sensors 126 that may be included in the sensing module 120.

In addition, the electronic shelf label 100 may adjust information displayed on one or more virtual cells based on the external environment information using a controller 130 (S730). A method for adjusting, by the controller 130 of the electronic shelf label 100, the information displayed on the one or more virtual cells based on the external environment information is the same as described with reference to FIG. 3, so a detailed description thereof is omitted.

Subsequently, the electronic shelf label 100 may communicate with a management server 200 using the controller 130 (S740). That is, the controller 130 of the electronic shelf label 100 may transmit the external environment information obtained by the sensing module 120 to the management server 200 or receive the information generated based on the external environment information from the management server 200.

Subsequently, the electronic shelf label 100 may output the information adjusted based on the external environment information on the display 110 and through the speaker 140 (S750). That is, the controller 130 of the electronic shelf label 100 may control the display 110 and the speaker 140 to output the information adjusted in the above-described S730 or the information received from the management server 200 in the above-described S740.

The present disclosure has been described as described above with reference to exemplary drawings, but the present disclosure is not limited to the embodiments and drawings disclosed herein, and various modifications may be made by those skilled in the art within the scope of the technical idea of the present disclosure. Further, even if working effects obtained based on configurations of the present disclosure are not explicitly described in the description of embodiments of the present disclosure, effects predictable based on the corresponding configuration have to be recognized.

1. An electronic shelf label, comprising:
a display configured to display information to a user using one or more virtual cells;
a sensing module configured to obtain external environment information; and
a controller configured to control information displayed on the one or more virtual cells based on the external environment information obtained by the sensing module.

2. The electronic shelf label of claim 1,
wherein the sensing module comprises one or more cameras configured to obtain an image as the external environment information and
wherein the controller is configured to adjust the information displayed on the one or more virtual cells based on user information included in the image obtained by the one or more cameras.

3. The electronic shelf label of claim 2, wherein the controller is configured to:
transmit the image obtained by the one or more cameras to a management server and
receive information to be displayed on the one or more virtual cells from the management server.

4. The electronic shelf label of claim 1,
wherein the sensing module comprises one or more temperature sensors configured to obtain a temperature as the external environment information and
wherein the controller is configured to control the temperature obtained by the one or more temperature sensors to be displayed on the one or more virtual cells.

5. The electronic shelf label of claim 4, wherein the controller is configured to: based on the temperature obtained by the one or more temperature sensors being not within a preset reference temperature range, transmit an abnormality notification to a management server.

6. The electronic shelf label of claim 1,
wherein the sensing module comprises one or more humidity sensors configured to obtain humidity as the external environment information and
wherein the controller is configured to control the humidity obtained by the one or more humidity sensors to be displayed on the one or more virtual cells.

7. The electronic shelf label of claim 6, wherein the controller is configured to: based on the humidity obtained by the one or more humidity sensors being not within a preset reference humidity range, transmit an abnormality notification to a management server.

8. The electronic shelf label of claim 1,
wherein the sensing module comprises one or more illuminance sensors configured to obtain illuminance as the external environment information and
wherein the controller is configured to adjust brightness of the display based on the illuminance obtained by the one or more illuminance sensors.

9. The electronic shelf label of claim 1,
wherein the sensing module comprises one or more microphones configured to obtain a voice as the external environment information and
wherein the controller is configured to adjust the information displayed by the display based on the voice obtained by the one or more microphones.

10. The electronic shelf label of claim 1,
wherein the sensing module comprises one or more dust detection sensors configured to obtain concentration of dust in the air as the external environment information and
wherein the controller is configured to control the dust concentration obtained by the one or more dust detection sensors to be displayed on the one or more virtual cells.

11. The electronic shelf label of claim 1, further comprising a speaker configured to output a voice comprising the information displayed on the one or more virtual cells.

12. The electronic shelf label of claim 11, wherein the controller is configured to control: based on the display receiving an input of selecting any one of the one or more virtual cells from the user, only information displayed on a virtual cell selected by the user using the external environment information obtained by the sensing module.

13. A method for controlling an electronic shelf label, comprising:
displaying information to a user using one or more virtual cells of a display;
obtaining external environment information by a sensing module;
adjusting, by a controller, the information displayed on the one or more virtual cells based on the external environment information obtained by the sensing module; and
outputting, by the controller and on the display, the information displayed on the one or more virtual cells adjusted based on the external environment information.

14. The method of claim 13,
wherein obtaining the external environment information comprises obtaining an image as the external environment information by one or more cameras of the sensing module,
wherein adjusting the information displayed on the one or more virtual cells comprises: adjusting, by the controller, the information displayed on the one or more virtual cells based on user information comprised in the image obtained by the one or more cameras and
wherein adjusting the information displayed on the one or more virtual cells further comprises:
transmitting, by the controller, the image obtained by the one or more cameras to a management server after obtaining the image as the external environment information by the one or more cameras; and
receiving, by the controller, information to be displayed on the one or more virtual cells from the management server.

15. The method of claim 13,
wherein obtaining the external environment information comprises obtaining a temperature as the external environment information by one or more temperature sensors of the sensing module,
wherein adjusting the information displayed on the one or more virtual cells comprises: controlling, by the controller, the temperature obtained by the one or more temperature sensors to be displayed on the one or more virtual cells,
wherein adjusting the information displayed on the one or more virtual cells further comprises transmitting, by the controller, an abnormality notification to a management server based on the temperature obtained by the one or more temperature sensors being not within a preset reference temperature range.

16. The method of claim 13,
wherein obtaining the external environment information comprises obtaining humidity as the external environment information by one or more humidity sensors of the sensing module,
wherein adjusting the information displayed on the one or more virtual cells comprises controlling, by the controller, the humidity obtained by the one or more humidity sensors to be displayed on the one or more virtual cells, and
wherein adjusting the information displayed on the one or more virtual cells further comprises transmitting, by the controller, an abnormality notification to a management server based on the humidity obtained by the one or more humidity sensors being not within a preset reference humidity range.

17. The method of claim 13,
wherein obtaining the external environment information comprises obtaining illuminance as the external environment information by one or more illuminance sensors of the sensing module and
wherein obtaining the external environment information further comprises adjusting, by the controller, brightness of the display based on the illuminance obtained by the one or more illuminance sensors.

18. The method of claim 13,
wherein obtaining the external environment information comprises obtaining a voice as the external environment information by one or more microphones of the sensing module and
wherein adjusting the information displayed on the one or more virtual cells comprises adjusting, by the controller, the information displayed by the display based on the voice obtained by the one or more cameras.

19. The method of claim 13,
wherein obtaining the external environment information comprises obtaining a concentration of dust in the air as the external environment information by one or more dust detection sensors of the sensing module and
wherein adjusting the information displayed on the one or more virtual cells comprises controlling, by the controller, the dust concentration obtained by the one or more dust detection sensors to be displayed on the one or more virtual cells.

20. The method of claim 13, wherein adjusting the information displayed on the one or more virtual cells comprises: adjusting, by the controller, only information displayed on the virtual cell selected by the user using the external environment information obtained by the sensing module based on the display receiving an input of selecting any one of the one or more virtual cells from the user.
